(19) United States
(12) Patent Application Publication
(10) Pub. No.: US 2009/0151266 A1
(43) Pub. Date: Jun. 18, 2009

(54) OUTER BELT WEATHERSTRIP WITH SNAP-ON MOLDED SHELL

(75) Inventor: Gennadiy Shumulinskiy, Oak Park, MI (US)

Correspondence Address: Fay Sharpe LLP, 1228 Euclid Avenue, 5th Floor, The Halle Building, Cleveland, OH, 44115, US

(73) Assignee: Cooper-Standard Automotive Inc.

(21) Appl. No.: 11/956,056

(22) Filed: Dec. 13, 2007

(51) Int. Cl. E06B 7/16

(52) U.S. Cl. 49/489.1; 49/506; 49/492.1

(57) ABSTRACT

A weatherstrip is adapted for use on an associated vehicle. It includes a body, preferably an extruded body, and has a gripping portion for securing the body to the vehicle. A retaining leg flexibly extends from the body, and a retaining shoulder is spaced from the leg. A separately molded outer shell has a retaining portion dimensioned for receipt between the retaining leg and the body. In addition, a shoulder of the retaining portion is dimensioned for operative engagement with the retaining shoulder of the body. In this manner, the shoulders of the shell and body snap-fit over one another and the shell is secured to the body.

### BACKGROUND

This disclosure relates to an automotive weatherseal or weatherstrip such as an outer belt, glass run, etc., and particularly a weatherstrip of the type employing an aesthetic show surface. It will be appreciated that this disclosure relates to a weatherstrip assembly that employs the benefits of an extruded or coextruded structure, as well as associated benefits of a molded arrangement.

Known construction of weatherstrips of this general type, namely outer belts sealed with an aesthetic pleasing, shiny, or bright show surface, are generally made by a thermoset or thermoplastic elastomer that is coextruded with stainless steel. Alternatively, stainless steel or anodized aluminum caps may be mechanically attached to the thermoset or thermoplastic elastomer portions of an extruded outer belt seal. These types of known constructions usually require extensive secondary trim operations in order to create a complex geometry such as notches and end cuts. In addition, these assemblies require additional components such as end caps, molded inserts with threaded openings, molded caps with integral snapping retention features, etc. along with assembly operations. Unfortunately, numerous additional components, secondary trim and assembly operations not only add to the expense of the assembly, but often have various quality issues such as mismatch, scratches, etc. along with high scrap rates.

Although extruded weatherstrips may be simply formed as a coextrusion of a rigid core in a cover layer of a thermoplastic or elastomeric material over at least a portion of the periphery of the core profile, the cost savings associated with ease of assembly are sometimes outweighed by the limitations associated with an extruded cross-sectional profile. Likewise, it is often desired to include end members, and incorporating end members in an extruded arrangement requires additional manufacturing steps. The end members serve both an aesthetic and functional feature, i.e. aesthetically limiting visible seams of separate components, or to functionally prevent snagging of clothing, to preclude water ingress, and to limit noise associated with a gap in the absence of end members.

Still another option is to provide a combination of extruded portions and molded portions (or a separately assembled component onto the underlying extrusion body). The intent of these combined structures is that an aesthetic show surface or decorative portion may be joined to an extruded portion and the combined structure provides some of the benefits associated with a weatherstrip that is extruded and other benefits associated with a molded arrangement. However, such a composite component does not lend itself to aesthetic and functional end members, sometimes referred to as integral end treatments, much less incorporating integral attachment features. Specifically, the geometries associated with integral or unitary attachment features and integral or unitary end treatments are at odds with the extruded profile and present unique and difficult design and manufacturing issues.

Thus, a need exists for a weatherstrip, such as an outer belt assembly, that advantageously combines numerous parts, simplifies extensive trim and assembly operations, provides a wrapped end look without unsightly joint lines associated with end caps, has minimal scrap rate, and is less expensive than known arrangements which provide the same features.

### SUMMARY OF THE INVENTION

A weatherstrip for use on an associated vehicle includes a body having a gripping portion for securing the body to the associated vehicle. A retaining leg flexibly extends from the body, and a retaining shoulder is spaced from the leg. A shell having an outwardly facing show surface includes a retaining portion dimensioned for receipt between the retaining leg and the body, and a shoulder dimensioned for operative engagement with the body retaining shoulder. The body retaining leg flexes outwardly to receive the shell retaining portion, and the shell shoulder snap-fits beneath the retaining shoulder of the body.

The shell includes first and second integral end treatments that are unitarily formed on opposite ends of the shell and dimensioned to overlie opposite ends of the body.

The body further includes a flexible hinge region at one end of the retaining leg that allows limited flexing of the retaining leg relative to the body and permits insertion of the shell retaining portion.

The shell is preferably a substantially rigid structure that has limited flexing along its longitudinal extent.

The shell includes an attachment member unitarily formed therein.

The body preferably has an extrudable cross-sectional profile.

A method of assembling the weatherstrip includes providing a body having a gripping portion for securing the body to the associated vehicle, and a retaining leg flexibly extending from the body with a retaining shoulder spaced from the leg. The method includes securing a shell to the body where the shell has a show surface, a retaining portion dimensioned for receipt between the retaining leg and the body, and a shoulder dimension for operative engagement of the retaining shoulder of the body so that the show surface is exposed when the shell is secured to the body.

The shell securing step includes positioning integrally formed end treatments over opposite ends of the body.

The shell securing step includes flexing the retaining leg outwardly from the body to receive the shell retaining portion therein.

The shell securing step further includes snapping the shell shoulder relative to the retaining shoulder after the flexing step.

The method further includes extruding the body and molding the shell.

A primary benefit of the disclosure is the advantageous inclusion of both extruded and molded features of a weatherstrip in a single structure.

Another benefit resides in an exterior molded shell having wrapped end treatments and molded in attachment features that can be easily joined to an extruded portion of a weatherstrip assembly.

Still another benefit is associated with the ease of assembly.

Yet another advantage of the invention is associated with the ease of assembly while retaining the cost benefits of an extruded assembly and the aesthetic and functional advantages of a molded show surface.

Still other features and benefits of the disclosure will become apparent upon reading and understanding the following detailed description.

### BRIEF DESCRIPTION OF THE DRAWINGS

FIG. 1 is is a cross-sectional view taken generally along the lines 1-1 of FIG. 2 of a weatherstrip, such as an outer belt, mounted to an associated automotive vehicle.

FIG. 2 is a perspective view of the weatherstrip of FIG. 1 taken generally from the rear and end portion thereof.

FIG. 3 is a rear perspective view of the molded portion or cap of the weatherstrip.

FIG. 4 is a front, perspective view of the cap of FIG. 3.

FIG. 5 is a perspective view of the assembled weatherstrip.

FIG. 6 is a perspective view of the weatherstrip of FIG. 5 and illustrating a rear portion thereof.

### DETAILED DESCRIPTION OF THE PREFERRED EMBODIMENTS

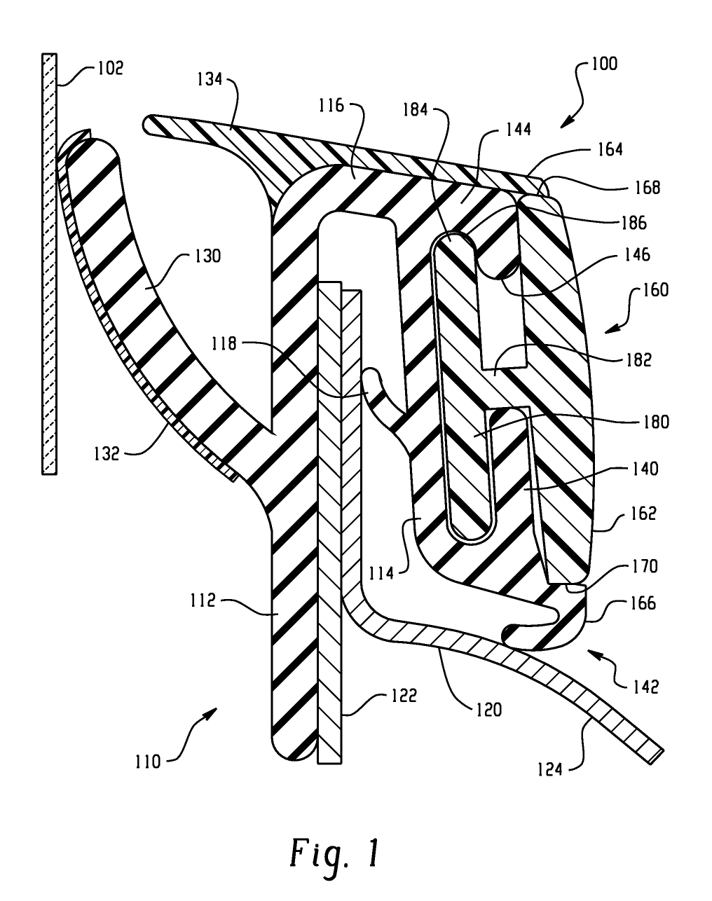

FIGS. 1-3 show a weatherseal or weatherstrip 100 for use in association with an automotive vehicle (not shown). The vehicle includes a glass or window 102 such as on an automotive vehicle door where the weatherstrip is an outer belt for example. The weatherstrip is initially formed as two components, namely, an extruded portion or body 110 that includes first and second legs 112, 114 that are joined together at an upper end by interconnecting portion 116. A flange mounting portion, such as one or more gripping fingers 118, extends inwardly into a generally inverted U-shaped cavity defined by the legs 112, 114 and is adapted to engage a vehicle flange such as door flange 120 formed where inner and outer door panels 122, 124 are joined together. The weatherstrip is adapted for insertion over the door flange 120 so that the leg portions 112, 114 are received on opposite sides thereof and the flange mounting portion or gripping finger 118 prevents inadvertent removal of the outer belt weatherstrip.

In addition, one or more sealing lips 130 extend in an opposite direction from the flange mounting portion or outwardly from an outer surface of the second leg 112. Preferably each sealing lip includes a low friction surface 132 formed thereon for sliding, sealing engagement with a surface of the window in a manner generally well known in the art. A hiding or cover lip 134 may also extend outwardly from the extruded component 110 and preferably is located to close off a gap of the upper sealing lip where the sealing lip engages the window.

In addition, a retaining leg 140 is connected to leg 114 of the extrusion body via a flexible hinge 142. As will be described in greater detail below, the flexible hinge allows the retaining leg 140 to be pivoted outwardly, i.e., away from leg 114, due to the flexibility in the hinge region 142. Likewise, a normal unbiased state of the flexible hinge disposes the retaining leg 140 in generally parallel relation with leg 114 of the body. Extending from the opposite end of leg 114 is a retaining shoulder 144 that has a generally rounded contour 146 for reasons which will become more apparent below.

The body comprised of legs 112, 114 and interconnecting region 116, along with the seal lip 130, low friction surface 132, hiding lip 134, flexible hinge 142, retaining leg 140, and the retaining shoulder 144, are all preferably a unitary or integral extrusion. This does not necessarily mean that the same materials are used for each of these portions of the extruded body. Rather, one skilled in the art will recognize that different materials will be coextruded to provide different functions. For example, the seal lip 130 and low friction surface 132 are intended to provide a flexible, sliding, sealing interface with the surface of the window. The legs 112, 114, and interconnecting region 116 are generally a more rigid structure and may include a rigid core such as an aluminum strip or rigid polymer core. Similarly, the retaining leg 140 and retaining shoulder 144 are preferably a more rigid structure than the sealing lip. Thus, these legs and interconnecting region are shown in a cross-hatching evident of a similar type of material that is more rigid than the flexible nature of the seal lip. Likewise, the flexible hinge region 142 is preferably formed from the same or a different flexible material as the hiding lip and seal lip. This allows for the hinged or pivoting movement of retaining leg 140 about an axis that is generally parallel to a longitudinal axis of the weatherstrip and relative to the rest of the extruded body as will be described further below.

The second major component of the weatherstrip is a molded shell 160. The shell has an outwardly facing surface generally referred to as a show surface 162 that faces outwardly from the vehicle when secured to the extruded body for providing an aesthetic feature on an external surface of the automotive vehicle. Shell 160 is shown in cross-section as having a generally H-shaped configurational, although one skilled in the art will appreciate that one or more of the legs may be shorter or longer relative to the others and slightly alter the cross-sectional configuration from the illustrated H-shape. Outer show surface 162 can be formed from a variety of materials such as thermoplastic materials that may be of a desired color or gloss relative to the extruded body or to coordinate with the remainder of the vehicle. Likewise, this show surface can be painted or chrome plated if so desired.

Preferably the show surface has a width dimension that extends between overhanging flanges 164, 166 from the extruded body. More particularly, flange 164 is a continuation of the hiding lip on the exterior portion of the extruded body while flange 166 is provided as an extension of the flexible hinge region 142. The flanges are preferably formed from the flexible material to provide some compliancy and adapted to extend over terminal upper or lower edges 168, 170 of the show surface. The flanges provides a smooth transition between the separately molded cap when the cap is assembled to the separately formed, extruded body.

The molded shell 160 further includes a retaining portion, shown in this arrangement as a leg 180, that is offset from and parallel to the show surface. An interconnecting region 182 offsets the retaining portion 180 by a dimension that closely approximates that of the retaining leg 140 of the extruded body. Moreover, an upper region of the retaining portion 180 forms a shoulder 184 having a rounded surface 186 that cooperates in snap-fit relation with the rounded surface 146 of the retaining shoulder of the body.

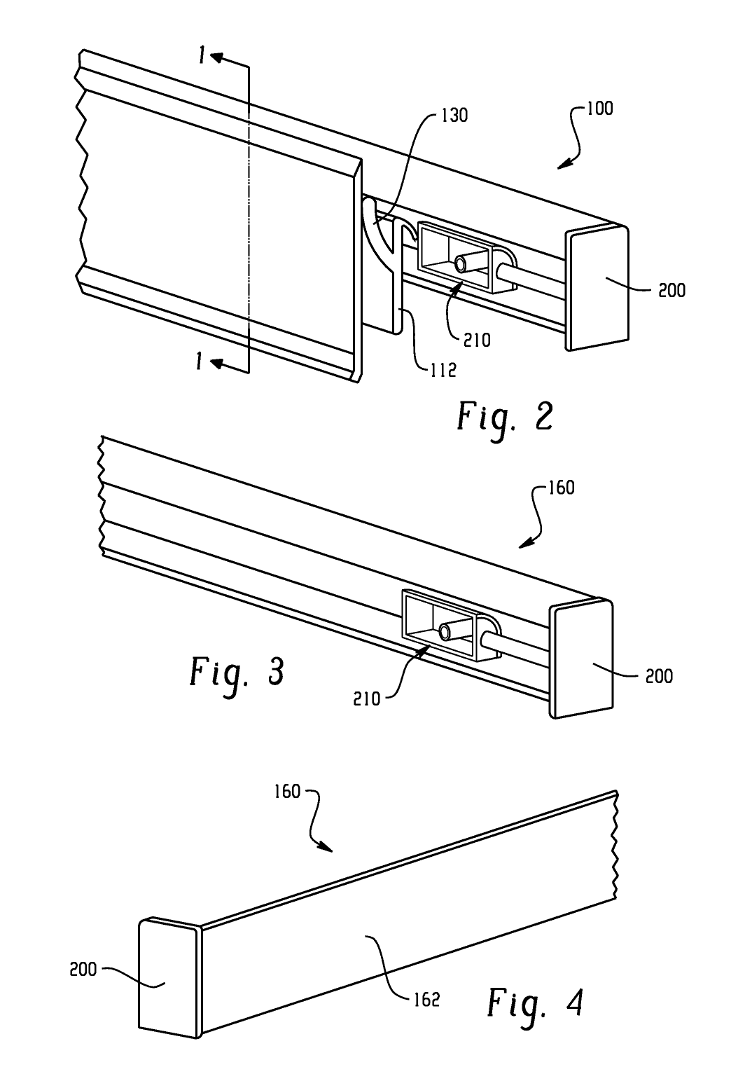

With continued reference to FIGS. 1 and 2, and additional reference to FIGS. 3 and 4 which separately illustrate the molded shell, further particular details of the shell will now be described. As shown, the molded shell preferably includes integral end treatments or caps 200 which are dimensioned to overlie and enclose the terminal ends of the extruded body (see FIG. 2). As will be appreciated, in a weatherstrip that is formed from only an extruded component, the inclusion of integral end treatments of this type is not possible. Thus, extensive trim and assembly operations, as well as numerous components, are required to provide a wrapped end look without an unsightly joint line that typically results from the use of separate, outer belt end treatments or caps. Here, the end caps 200 are formed as part of the molded shell and dimensioned to overlie at least a portion of opposite terminal ends of the extruded body (see FIG. 2). This arrangement eliminates the gap between the ends of the outer belt and the adjacent glass run, which thereby improves sealing and wind noise, as well as providing a more aesthetically desirable interface.

In addition to the integrated end treatments or end caps 200, an integral or unitary vehicle attachment feature 210 is preferably molded into a rear face of the shell preferably at ends where the moulding extends beyond the extrusion body. Thus as evident in FIGS. 2 and 3, the vehicle attachment feature 210 is integrally molded into the shell. As further shown in FIG. 6, the attachment feature cooperates with a fastener 212 in a door flange, or in a similar structure, for example where the weatherstrip is not an outer belt, to secure the weatherstrip assembly to the associated automotive vehicle. In the illustrated embodiment, the particular integrated vehicle attachment feature 210 is an opening that receives a self threaded fastener, for example, although other fastening arrangements could be used with equal success such as a push pin, mushroom-cap fasteners, etc.

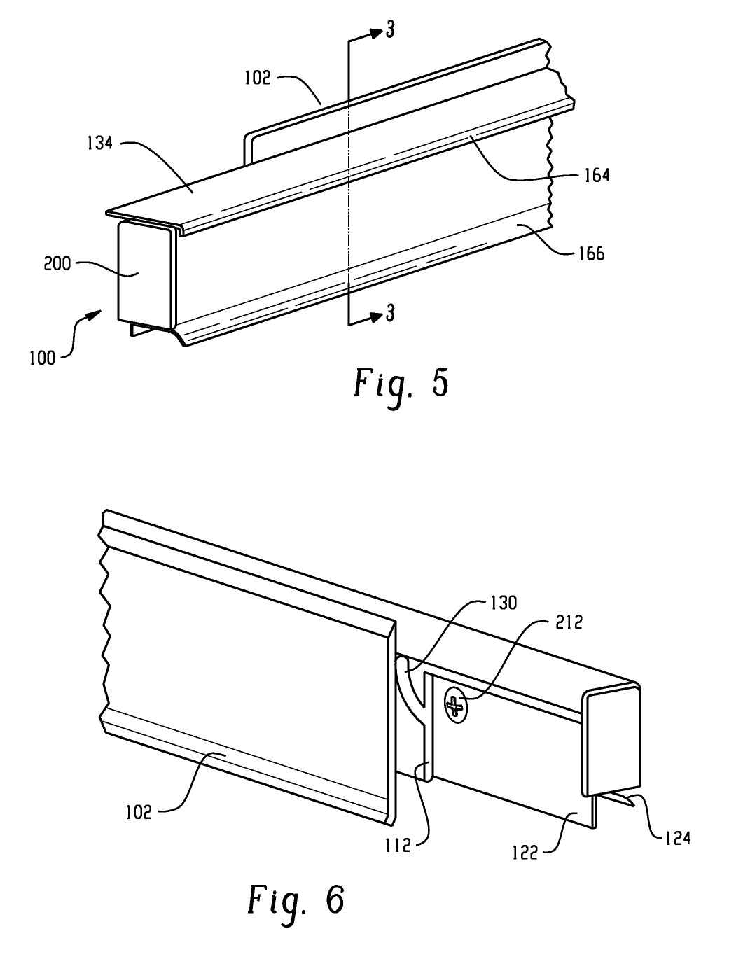

The final assembly of FIGS. 1, 5, and 6 preferably provides a weatherstrip that serves the purposes of combining numerous parts, simplifying the trim and assembly operations, and providing a wrapped end look without an unsightly joint line. Moreover, the snap on molded shell can include end features. The shell can also advantageously include vehicle attachment features, as well as providing for a wide variety of design options where the molded component can be formed with different colors, gloss, chrome-plated, painted, etc.

Preferably, the molded shell is a generally rigid structure. In order to mount the shell to the body, the retaining leg 140 of the extruded body is pivoted about the flexible hinge 142 (in a generally clockwise direction from the position shown in FIG. 1). Once the retaining leg 140 has been rotated outwardly, the retaining portion 180 of the shell can then be inserted over retaining leg 140, and the retaining leg then rotated in the opposite direction, i.e. counter-clockwise. As the retaining leg is rotated back toward the final position shown in FIG. 1, shoulder 184 of the shell abuts against the retaining shoulder 144 of the body. The rounded surfaces 186, 146, respectively, permit the shoulders to slide by one another or snap-fit into connection once a predetermined force is applied. The flexible hinge, as well as the flexible nature of the elastomeric materials, permits this snap-fit feature to occur such that the shoulder 184 is then securely retained by the retention shoulder 144 of the body. It will also be appreciated that the upper and lower terminal edges 168, 170 of the shell are then preferably retained within the flanges 164, 166 as shown in FIG. 1. Once snapped into place, the molded shell cannot be easily removed from the installed position shown in FIG. 1.

The invention has been described with reference to the preferred embodiments. Alterations and modifications will be apparent to those skilled in the art. However, the present disclosure should be construed as including all such modifications and alterations insofar as they come within the scope of the appended claims or the equivalents thereof.

1. A weatherstrip for use on an associated vehicle comprising:
a body having a gripping portion for securing the body to the associated vehicle, the body including a retaining leg flexibly extending from the body, and a retaining shoulder spaced from the leg; and
a shell having a show surface, a retaining portion dimensioned for receipt between the retaining leg and the body, and a shoulder dimensioned for operative engagement with the retaining shoulder whereby the retaining portion is received between the retaining leg and the body, and the shoulder snap-fit beneath the retaining shoulder such that the show surface of the shell is exposed.

2. The weatherstrip of claim 1 wherein the shell further includes first and second end treatments unitarily formed on opposite ends thereof that overlie opposite ends of the body.

3. The weatherstrip of claim 1 wherein the body further includes a flexible hinge region at one end of the retaining leg that allows limited flexing of the retaining leg relative to the body and insertion of the shell retaining portion therebetween.

4. The weatherstrip of claim 1 wherein the shell is a substantially rigid structure that has limited flexing along its longitudinal extent.

5. The weatherstrip of claim 1 wherein the retaining portion and the shell shoulder are disposed in opposite facing directions.

6. The weatherstrip of claim 1 wherein the retaining leg and shoulder form an H-shaped extension from a surface of the shell opposite from the show surface.

7. The weatherstrip of claim 6 wherein the retaining leg is spaced from a rear surface of the shell and forms a longitudinally extending slot dimensioned to receive the retaining leg therein.

8. The weatherstrip of claim 1 wherein the shell includes a vehicle attachment member unitarily formed therein.

9. The weatherstrip of claim 1 wherein the body has an extrudable cross-sectional profile.

10. The weatherstrip of claim 1 wherein the body retaining shoulder and the shell shoulder each include an inclined surface allowing the shoulders to snap-fit over one another.

11. A method of assembling a weatherstrip for use on an associated vehicle comprising:
providing a body having a gripping portion for securing the body to the associated vehicle, the body including a retaining leg flexibly extending from the body, and a retaining shoulder spaced from the leg; and
securing a shell to the body, the shell having a show surface, a retaining portion dimensioned for receipt between the retaining leg and the body, and a shoulder dimensioned for operative engagement with the retaining shoulder whereby the retaining portion is received between the retaining leg and the body, and the shoulder is snap-fit beneath the retaining shoulder such that the show surface of the shell is exposed.

12. The method of claim 11 wherein the shell securing step includes positioning end treatments over opposite ends of the body.

13. The method of claim 11 wherein the shell securing step includes flexing the retaining leg outwardly from the body to receive the shell retaining portion therein.

14. The method of claim 13 wherein the shell securing step includes snapping the shell shoulder over the retaining shoulder after the flexing step.

15. The method of claim 11 wherein the providing step includes extruding the body.

16. The method of claim 11 further comprising molding the shell.

17. A weatherstrip for an associated vehicle that includes a flange, the weatherstrip comprising:
a body received on the associated vehicle, the body including retaining leg flexibly extending therefrom, and a retaining shoulder spaced from the leg; and
a rigid shell having a show surface and a retaining portion dimensioned for operative engagement with the retaining shoulder of the body whereby the retaining portion is received between the retaining leg and the body, and the shoulder snap-fits beneath the retaining shoulder such that the show surface of the shell is exposed.

18. The weatherstrip of claim 17 wherein the body further includes a flexible hinge region in the retaining leg that allows limited flexing of the retaining leg relative to the body about an axis generally parallel to a longitudinal axis of the weatherstrip.

19. The weatherstrip of claim 18 wherein the shell further includes first and second end treatments unitarily formed on opposite longitudinal ends thereof that overlie opposite ends of the body.

20. The weatherstrip of claim 19 wherein the body retaining shoulder and the shell shoulder each include a rounded surface allowing the shoulders to snap-fit over one another.
